(19) United States
(12) Patent Application Publication
(10) Pub. No.: US 2010/0203945 A1
(43) Pub. Date: Aug. 12, 2010

(54) Chance-board game method and system

(76) Inventors: Ronald L. Pitocchelli, Amesbury, MA (US); David W. Fisher, Woburn, MA (US)

Correspondence Address: Marc J. Miller, Esquire;Suite 205, 220 Broadway, Lynnfield, MA, 01940, US

(21) Appl. No.: 12/322,943

(22) Filed: Feb. 10, 2009

(51) Int. Cl. A63F 9/24; A63F 13/00

(52) U.S. Cl. 463/19; 463/30; 463/42

(57) ABSTRACT

A method and system for a chance-board-game with a board presentation and numerical matrix to define position and focus for chance game. The apparatus (G-Box) is a portable gaming device which includes an addressable touch screen with advanced networking, security and video graphics enabling a player to concurrently participate in multiple games of chance. Menu driven with an imbedded matrix processor, the device allows a player to actively or passively participate in multiple games, including CHINGO WORLD™ Games, Bingo, Keno, Roulette, Slot Machines and with an imbedded Alert and Notification Processor (ANP) that empowers a chance player to not only accurately play hundreds of game “cards” but also automatically monitor complex games and thus not miss any “wins” while complying with all game win notification requirements. The 6×6 matrix CHINGO game may be played using the apparatus (G-Box) for active or passive gaming or CHINGO games may be played using traditional manual cards and sheets of cards. The apparatus (G-Box) is designed to facilitate gaming within a gaming facility (Casino) or to participate in controlled open gaming through a standard cable and a national CHINGO gaming network.

### FIELD OF THE INVENTION

This invention relates to a method and system for playing a CHINGO WORLD™ or other chance game using a purpose built display appliance (G-Box) in either a casino or national cable network, market enabled by advanced telecommunication networking. The appliance (G-Box) enables a player to Play games of chance, pay for games, make bets and receive winnings—all utilizing the appliance (G-Box) that provides a secure access to a secure network environment.

### BACKGROUND OF THE INVENTION

Various methods and systems for playing board games over a wide geographic area have been proposed.

In U.S. Pat. No. 5,351,970, issued to Fioretti, there is shown and described a system for enabling bingo to be played over a wide geographic area. The system described in Fioretti '970 issues game card arrays in response to purchase requests. This means includes a point of sale terminal and a system base station for issuing valid game card arrays. Track is kept of all game card arrays issued in response to purchase requests. Sequencing is through each bingo game on a scheduled bingo session; and communication is over a wide geographic area, with a sequence of random symbols being generated during a particular bingo game. This method enables players over a wide geographic area to participate in a bingo session. In U.S. Pat. No. 5,569,083, which also issued to Fioretti, there is shown and described a system and method for playing bingo over a wide geographic area, having an on-line point of sale terminal for issuing valid game card arrays and keeping track of all game card arrays. Sequencing is through each bingo game in a scheduled bingo session and communication is over a wide geographic area with the sequence of random symbols being generated during a particular bingo game. In alternative embodiments, the system of Fioretti '083 further provides a communication path for allowing a game participant to interact with the system.

U.S. Pat. No. 5,857,911, which again issued to Fioretti, shows and describes a method and system for enabling bingo and similar games of chance to be played in real time at locations which are geographically separated from the locations where the numbers used to play a bingo type of game are being selected.

In U.S. Pat. No. 5,830,069, which issued to Solteaz et al., there is shown and described a system with a central site Personal Computer (“PC”) with gaming control controlling a gaming event, a private Wide Area Network (“WAN”) connected to the central site PC, and at least one participation site with at least one participant and a participation site PC. Each central site PC communicates video and non-video information of the gaming event to each participation site PC through the WAN. Further, each participation site PC communicates information regarding the participation of the participants in the gaming event to the central site PC through the WAN.

In U.S. Pat. No. 6,585,590 which issued to Malone Jul. 1, 2003 for Method and system of operating a bingo game on the internet the disclosure is of a method of operating a bingo game using a game server on a network, by providing a plurality of game cards and enabling players to purchase game cards by using a remote game client computer. At least one purchased card is a winning game card. After suspending the purchase of game cards, numbers are generated to obtain a sequence of calls. The sequence of calls is applied to each purchased game card to identify at least one winning game card. The sequence of calls is transmitted to each remote game client computer which has been used to purchase at least one game card; and, on each remote game client computer, the sequence of applied calls is repeated until the at least one winning game card is identified

While the prior art methods and systems teach how the game of bingo and similar games of chance can be played interactively over a wide geographic area, one disadvantage is that they fail to address the problem of ensuring fairness for all players playing the game when some players have an unfair advantage in terms of network connection speed and access.

### SUMMARY OF THE INVENTION

In accomplishing the foregoing and related objectives, the invention provides a game board (CHINGO) in the form of a matrix with a plurality of columns and rows, with each intersection of a row and column forming a playing area, and the first row title includes, for each playing area an alphabetic designation.

In accordance with one aspect of the invention the game board has six rows and six columns, with each intersection of a row and column defining an active playing area.

In accordance with another aspect of the invention the game board has the first column alphabetically designated by the letters C and the appliance (G-Box) responds electronically to numbers ranging from 1 to 18; the second column is alphabetically designated by the letter H and the appliance (G-Box) responds electronically to numbers ranging from 19 to 36; the third column is alphabetically designated by the letter I and the appliance (G-Box) responds electronically to numbers ranging from 37 to 54; the fourth column is alphabetically designated by the letter N and the appliance (G-Box) responds electronically to numbers ranging from 55 to 72; the fifth column is alphabetically designated by the letter G and the appliance (G-Box) responds electronically to numbers ranging from 73 to 90; and the sixth column is alphabetically designated by the letter O and the appliance (G-Box) responds electronically to numbers ranging from 91 to 108; whereby the game board provides for 108 numbers. In each of the six columns there are six rows, the value of each intersection of column and row must be within the column's numeric range without value duplication in any column.

In the CHINGO game the number of unique cards and the number of winning squares necessary to win a game are increased greatly over the same parameters in conventional board games, thereby enabling a larger number of potential players, lengthening the time for each game and broadening the spectrum of potential players per game. The number and type of potential CHINGO game variations follows, but are not limited to, standard and special industry card game win requirements of: full row, full column, full diagonal, L, Double-T, C, Perimeter, Small Perimeter, Full Small Box and Black-out. The expanded gaming and population potential is focused and necessary to enable a vastly expanded public cable network market while enabling CHINGO gaming to be introduced to a limited card, single non appliance (G-Box) player.

Introduce the appliance (G-Box) and a network CHINGO WORLD™ gaming venue, within or external to a casino venue, and allow, permit and encourage paper cards—the games will last longer, prizes will be larger and the CHINGO WORLD™ Cable Network and Casino gaming atmosphere will exceed conventional card and machine enhanced gaming. Client atmosphere and excitement for CHINGO gaming is assured with number selection chosen through the traditional “air ball fall in the bin” process. The appliance (G-Box) enables a player to play in excess of 100 CHINGO “cards”, participate in “live” electronic roulette and play a traditional slot machine—simultaneously—The number of bets per minute per player can dramatically increase. The player knows with the appliance (G-Box) their “in play” position can dramatically increase while their gaming attention remains constant.

With the appliance (G-Box), an interactive digital cable technology and the concurrence of a distributed or centralized casino, cable companies become the facilitators and distribution channel of domestic or world wide gaming. The CHINGO WORLD™ Network, (Cable), while enabling local and state gaming expansion, still permits revenue and jurisdiction control through licensing and local audit. Thus states may have desired gaming without any casino infrastructure issues. With the cable operator providing cable and network infrastructure access to the CHINGO WORLD™ Network, the interactive digital cable box(s) providing the interface to the gaming Network, the appliance (G-Box) providing secured access to any provided gaming casino or gaming venue, and the gaming control, payments-payouts and tax implications controlled by the interaction of the Casino (or virtual Casino) gaming network with the appliance (G-Box) and interactive digital cable box. However, the CHINGO WORLD™ Cable Network would be a stand alone cable network channel, viewed by anyone with a cable box who may view all the live gaming and excitement of CHINGO games and their progress, along with the marketing of casinos, gaming and betting, especially how a potential gamer may join in gaming at home, in a virtual or traditional casino or visit a local gaming hall to be an audience participant in CHINGO games. The open CHINGO WORLD™ Cable Channel will promote the availability of the appliance (G-Box), its features and universal usage and acceptance in Casinos, gaming cruses, KENO parlors and gaming institutions word wide.

The CHINGO WORLD™, CHINGO game board, is a purpose designed board game with an expanded matrix footprint and number of unique boards, expressly designed to embrace a vastly expanded world wide potential linked gaming community, while not eliminating the single board player.

The appliance (G-Box) display-monitor integrates technological advancements, not utilized in this manner before, allows a single user to play hundreds of games simultaneously while automatically and accurately tracking each game and proactively notifying the user their win position within the game. The appliance (G-Box), in its uniquely configurable capacity, allows a user to configure the appliance (G-Box) to play any acceptable casino game as CHINGO, Keno, Roulette, slots Baccarat, etc., complete with audio sounds, audio help and failure recovery—all utilizing a user friendly, non computer touch screen WYSIWYG (what you see is what you get) easy to use, approachable gaming tool. The appliance (G-Box) is bundled with advanced graphics, flexible and easily upgradeable gaming firmware, serialized secure and encrypted communications as well as RFID (Radio Frequency Identification) and magnet strip credit card reader for payments and credits. The advanced built in secure networking capability allows the appliance (G-Box) real time access, over the cable network, to the CHINGO WORLD™ Cable Network, enabling jurisdictional control and access to world wide gaming. The same appliance (G-Box) flexible configuration capability, allows the use of the appliance (G-Box) within the casino via secure wireless or wired access, to play multiple games in any area of the casino property, make payments and update their “personal gaming account” with credit cards, “wampum” gaming cards and pre-selected/agreed casino markers.

In the Casino mode of operation the Casino infrastructure and network will provide the necessary tight audit constraints. In the WAN (Wide Area Network) mode of operation the local cable operator provides the local access and Network Channel visibility (open channel) for the display and gaming while all security, payment, audit and validation is conducted by a traditional casino hosting the games or a designated virtual casino complete with resident studios, in house gaming guests and remote operations. Interactive Digital Cable and the CHINGO appliance (G-Box) will enable a gamer to play multiple games in venues from a structured Casino environment through their own directly supplied cable complete with a nationwide cable network gaming show. Gaming cruse vessels as well as aircraft will have access, world wide, to gaming while in unrestricted space. With a significant security and satellite up-down links to casino cable networks, gaming worldwide can become mobile with state licensed casinos competing for gaming bandwidth and revenue gain.

Other games, such as Bingo and Keno can be played concurrently with increased betting in non-gaming hall Convenience Stores, Lounge or social gatherings. The apparatus (G-Box) system enables “in casino” or external “virtual casino” play with multiple real time video game views, along with technology enhanced game monitoring. Play can be technology assisted active or passive, with the active player viewing and pre-viewing all aspects of the game while the passive player is empowered by the Active Monitor Mode (AMM), where the apparatus diligently reviews all plays, notifying the player of a win and any required game response.

The Game board display apparatus (G-Box) includes a touch screen, an Operating System which is a virus resistant with necessary drivers for Input/Output (I/O) and internal communications firmware with diagnoses upon startup and display of an appropriate error message indicating any difficulty; and can include snap-in hardware-firmware components configured as daughter boards on a mother board with slides/rails for easy removal/replacement; have rechargeable batteries and loading of game cards and information into a non-volatile flash memory, assuring no loss of gaming or betting information. Game positional information can be saved upon a forced re-boot or inadvertent power down on a power interrupt to allow an immediate network request for update that reloads all card/game parameters, and immediately place the user back in the game with no loss of a winning position.

The apparatus (G-Box) can form a base system delivered fully loaded with an Interactive Digital Cable Box interface, and be provided with Wireless Fidelity (WiFi), screen graphics, a Credit Card reader supporting both card swipe and Radio Frequency Identification (RFID), Audio Help and a Script memory (both Volatile and Flash) and an operating system that is fully operational in any enabled environment.

The Touch Screen Display can be provided with protected switches to avoid accidental operation, including the following switches: Power (on-off) “Lighted” (Green-on, Red-off); Standby (on-off); “Lighted Toggle” (Green-normal, Red-Standby);’ a: Large Illuminable Switch (flashing upon a win); Smaller duplicate illuminable switches and indicators on the edge while in closed “monitor” mode; and Indicator Lights to indicate Charging (flashing Red); Charge indication (tri-color): Continuous Bat. Condition (Green-50-100%; Yellow-20-50%; Red-5-20%; Flashing Red and tone at <5% with Low Power mode message

The apparatus can further include Twin Speakers with mini-volume rocker switching, Re-Boot indication (“Lighted”) and a Protected Emergency System Re-Boot indication (Red while enabled); Power Charger input, Plug for Earphone and Microphone, a common cable communication channel likened to “ether” (“Ethernet”); a serial bus interface for high-speed communication and asynchronies real-time data transfer; Universal Serial Bus (“USB”) Ports, a Multi-mode Fiber Dual Personal Computer (PCI) Card slot; Display output; a Swipe Credit Card Reader; a Personal Identification Verification (“PIV”) Processor; a Mother board with an Electrical Erasable Programmable Read Only Memory (“EEPROM”) “on board” operating system complete with standard Input-output (“I/O”) drivers and display interface; a volatile memory, a Flash non-volatile memory, a Basic Display processor, a Basic Audio board, a Standard touch screen with high light visibility, a Rechargeable Battery, a Daughter Board with optional add on adapters, and an Operating System Quick Charger.

The Mother Board can contain a microprocessor and back plane interface with pluggable daughter board pins for an Operating System and language processor for selected language options, an operational memory, a flash non volatile memory for “loaded” game boards (matrix), Keno, Lotto, Roulette and Baccarat betting and play selections; an Advanced Graphical Processor which is pluggable and upgradeable with imbedded micro processing and memory to control graphical display enabling a multiple split screen for presentation of game status, menu control, finger icon drag and drop and real time video and audio on a single screen; wherein the graphical processor presents not only a gaming matrix and real time video but also animated representations of Japanese and Chinese symbols and their associated chance games; and means for allowing direct connection and alternative interfacing to all variations of casino and private networks for operation and downloading when distributed broadband wireless fidelity (“WIFI”) technology is available.

The apparatus (G-Box) can further include a Game Controller; a Master Menu with loadable help, instructions and game specific sound files, pluggable and replaceable firmware game software whereby as a player broadens their game scope and network configurable options as casino gaming venues change with cable company variations—all with zero insertion hardware—firmware capabilities.

There can be an audio daughter board containing an imbedded processor for all audio applications, a speaker and headphone drivers, and a synthesizer for game specific sound and audio, help files from the Game Controller to process an audio digitally selectable sub channel communication link where a casino and virtual casino offer on line audio, and live help through either direct I/O or a WiFi link.

The WiFi link can be a specially adapted 802.11n distributed broadband wireless communication link supporting a standard 802.11n security protocol and additionally including an imbedded public key encryption chip linked with an apparatus serial number identifier with encrypted password protection.

A Credit Card Reader can be included with a -removable/swappable credit card swipe and short range “tap” Radio-Frequency Identification (“RFID”) smart card reader to build an internal “personal bank” for placing bets, purchasing game boards or registering for casino services and for registering gaming activity with a casino specific “players card” for points and credit. This reader can further be used with the “Wampum” type gaming tracking system to assist apparatus (G-Box) gamers to receive gaming credits.

The Power Supply can include 2—Nickel Metal Hydride (“NiMH) or Lithium Organic rechargeable batteries, Alternating Current (“AC”)charger and power management controls with the battery having a quick charge mode and be easily hot swappable with a fully charged battery—without loosing gaming position or requiring rebooting.

The Display Touch Screen can have a selectable high contrast mode for high ambient light conditions and be easily replaceable with “ruggedized” hinges.

A Utility Processor to monitor retain and process all critical applications (funds transfer, credit card confirmation, game status in low power situations) and act as the main controller during power up diagnostics and hardware trouble detection.

Game progress is monitored to the detail specified by the player allowing the player to switch to an Active Monitor Mode (AMM), enabling a player's participation in other virtual games or physical interaction at active table games as Black Jack or Craps or to leave the active gaming venue and be continuously and wirelessly linked to all games and be immediately notified of winning position and directed automatically to necessary and any required winning action to be taken with the casino.

A broad band interactive digital cable interface is used to enable virtual gaming outside a casino venue while assuring state jurisdiction and control of all gaming, whereby the interactive cable interface enables a cable company to establish a World network, complete with a dedicated channel where players and non players view gaming complete with domestic and international feeds and States can authorize and control casino, virtual casino and “at home” player access via their high speed interactive digital cable networks while the games played are at the discretion of the Governmental authorities.

### BRIEF DESCRIPTION OF THE DRAWINGS

For a better understanding of the present invention, and to show more clearly how it may be carried into effect, reference will now be made, by way of example, to the accompanying drawings which show a preferred embodiment of the present invention, and in which:

FIG. 1 is a schematic diagram of a game board in accordance with the invention;

FIG. 2 is a perspective view of an apparatus (G-Box) of the invention which Can incorporate the game board of FIG. 1;

FIG. 3 is a functional schematic diagram of a system of the invention incorporating the game box of FIG. 2; and

### DETAILED DESCRIPTION OF THE INVENTION

As mentioned, the present invention provides a method and a system for operating a CHINGO WORLD™ Game on a telecommunications system in a novel manner that gives access to a wide variety of players.

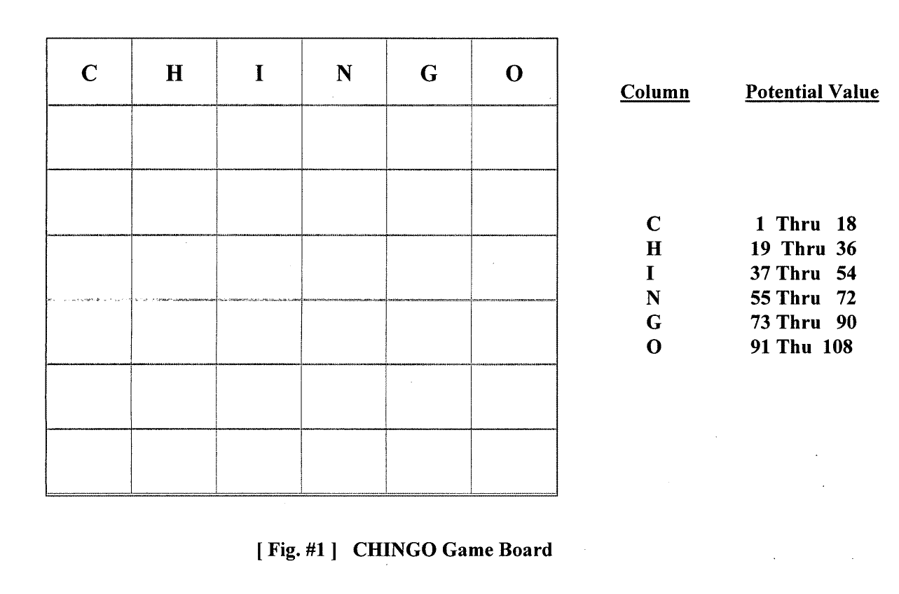

As shown in FIG. 1, the invention provides a game board in the form of a matrix with a plurality of columns and rows, with each intersection of a row and column forming a playing area. The game board has six active rows and six active columns, with each intersection of the six rows and columns defining an active playing area.

In accordance with another aspect of the invention the game board has the first active column alphabetically designated by the letters C and, and responds electronically and manually to numbers ranging from 1 to 18; the second column is alphabetically designated by the letters H and responds electronically and manually to numbers ranging from 19 to 36; the third column alphabetically designated by the letters I and responds electronically and manually to numbers ranging from 37 to 54; the fourth column alphabetically designated by the letters N and responds electronically and manually to numbers ranging from 55 to 72; the fifth column alphabetically designated by the letters G and responds electronically and manually to numbers ranging from 73 to 90; and the sixth column alphabetically designated by the letter O responds electronically and manually to numbers ranging from 91 to 108; whereby the game board provides for 108 electronic numbers. In each of the six columns there are six rows, the value of each intersection of column and row must be within the column's numeric range without value duplication in any column.

Since in the game board FIG. 1, the electronic and manual numbers can exceed the number of unique cards in conventional board games, this enables a larger number of potential players in a network gaming venue. When the game board is used in a casino venue, and played with paper cards, the games will last longer than conventional and provide the same atmosphere and excitement where the number selection is chosen through the traditional “air ball fall in the bin” process. Since the number of cards or bets a player can play can easily exceed one hundred, there is a dramatic potential increase in the bets with winning amounts and game length increasing dramatically.

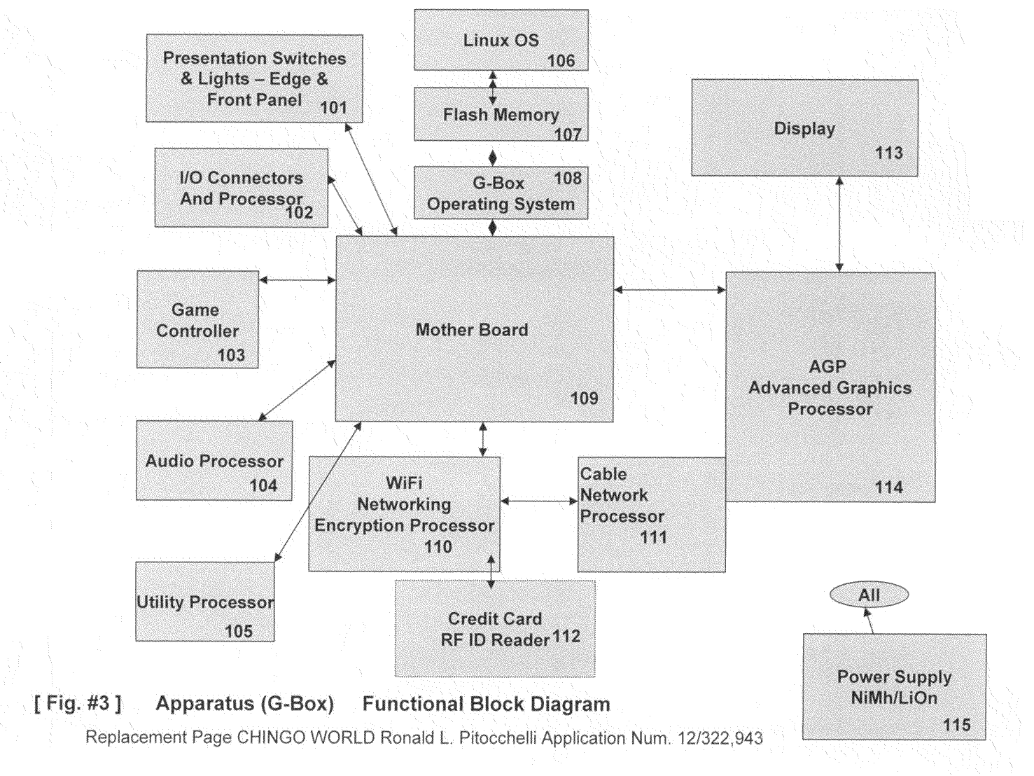

With game boards installed in the apparatus (G-Box) an addressable interactive digital cable technology can be enabled in the apparatus (G-Box) of FIG. 3 (#111), where a cable company can become the facilitator of the game with a cable operator supplying cable and an Interactive digital cable box access. An open network gaming channel(s) can be provided for marketing with real time video feeds for gaming productions and if the viewer has the CHINGO apparatus and the hardware and entertainment infrastructure of FIG. 3 can supply management structure or virtual or real casino operation and control.

The System of FIG. 3 (#103) permits other games, such as Bingo and Keno to be played concurrently with increased betting. This can empower non-gaming hall participant play. The system enables “in casino” or external “virtual casino” play with multiple real time video game views, along with technology enhanced game monitoring. Play can be technology assisted active or passive, with the active player viewing and pre-viewing all aspects of the game and the passive player be in the Active Monitor Mode (AMM), where the apparatus diligently reviews all plays, notifying the player of a win and the appropriate gaming response.

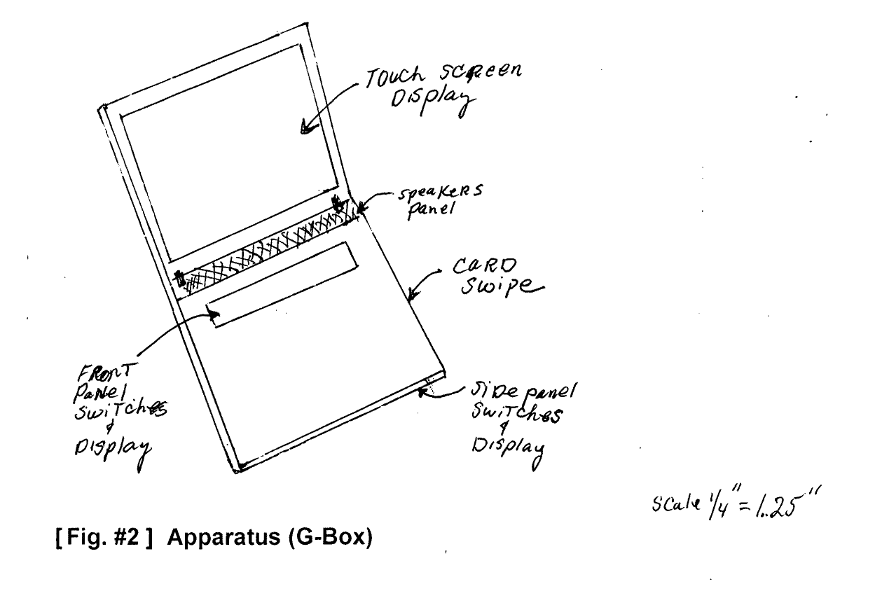

As shown in FIG. 2, the Game apparatus (G-Box) has no keyboard and all equipment activity is initiated and controlled by a touch screen an Operating System which is a virus resistant with necessary drivers for Input/Output (I/O) and internal communications firmware with diagnoses upon startup and display of an appropriate error message indicating any difficulty; and can including snap-in components configured as daughter boards on a mother board with slides/rails for easy removal/replacement; have rechargeable batteries and loading of game cards and information into a non-volatile flash memory, assuring no loss of gaming or betting information. Game positional information can be saved upon a forced re-boot or inadvertent power down on a power interrupt to allow an immediate network request for update that reloads all card/game parameters, and immediately place the user back in the game with no loss of a winning position.

The apparatus (G-Box) can form a base system of FIG. 3 delivered fully loaded with the I/O Connectors and Processor (#102) with an addressable Interactive Digital Cable Box interface (#111) in the form of a Local Area Network (“LAN”) cable with additional connectors to provide for a secure connection which is “locked” in place so that the cable will not pull out. The system is further provided with Wireless Fidelity (WiFi) (#110) which is a wireless technology owned by the WiFi Alliance for improving interoperability of Wireless Local Area Network (“WLAN”) components based on Institute of Electrical and Electronic Engineers (“IEEE”) 802.11 standards. Wi-Fi connectivity includes Internet and Voice over Internet (“VoIP”) phone access.

Touch screen graphics of Processor of FIG. 3 (#114) and a Credit Card reader (#112) support both card swipe and Radio Frequency Identification (RFID). RFID is an automatic identification method that stores and remotely retrieves data using tags or transponders RFID technology is disclosed in U.S. Pat. Nos. 3,713,148 and 4,384,288).

A Script memory FIG. 3 (#107) (includes both Volatile and Flash) and the operating system (#106) work together to provide a fully operational enabled environment to store, recover and operate the apparatus in low power mode to maximize operating time. The touch screen display FIG. 3 (113) can be provided with protected switches (#101) to avoid accidental operation. These include the following switches Power (on-off) “Lighted” (Green-on, Red-off); Standby (on-off); “Lighted Toggle (Green-normal, Red-Standby);’ Large Illuminable Switch (flashing upon a win); Smaller duplicate illuminable switch (flashing on edge while in closed “monitor” mode); and Indicator Lights to indicate Charging (flashing Red); Charge indication (tri-color): Continuous Bat. Condition (Green-50-100%; Yellow-20-50%; Red-5-20%; Flashing Red and tone at <5% with Low Power mode message The System of FIG. 3 can further include an Audio Processor (#104) with Twin Speakers with mini-volume rocker switching, Re-Boot indication (“Lighted”) and a Protected Emergency System Re-Boot indication (Red while enabled); Power Charger input, Plug for Earphone and Microphone. The I/O FIG. 3 (#102) includes an “Ethernet” common cable communication channel, along with a serial bus interface for high-speed communication and isochronous real-time data transfer.

Also provided with the apparatus (G-Box) (#102) Universal Serial Bus (“USB”) Ports, a Multi-mode Fiber Dual Personal Computer (PCI) Card slot; a Swipe Credit Card Reader (#112); a Personal Identification Verification (“PIV”) Processor (with (#110); a Mother board FIG. 3 (#109) with an Electrical Erasable Programmable Read Only Memory (“EEPROM”) “on board” operating system complete with standard Input-output (“I/O”) drivers and drivers for display interface; a volatile memory, a Flash non-volatile memory, a processor for Basic Display, a Basic Audio board, a Standard touch screen FIG. 3 (#113) with high light visibility, a Rechargeable Battery, a Daughter Board with optional add on adapters, and an Operating System Quick Charger in the Power Supply FIG. 3 (#115).

The Mother Board (#109) can contain a microprocessor and back plane interface with pluggable daughter board pins for an Operating System, an operational memory, a flash non volatile memory for “loaded” game boards (matrix), Keno, Lotto and Roulette betting and play selections (#103); an Advanced Graphical Processor (#114) which is pluggable and upgradeable with imbedded micro processing and memory to control graphical display enabling split screen presentation of game status, menu control, finger icon drag and real time video and audio on a single screen; wherein the graphical processor presents not only a gaming matrix and real time video but also animated slots and Japanese and Chinese symbols and their associated chance games; and means for allowing direct connection and alternative interfacing to all variations of casino and private networks for operation and downloading when distributed broadband wireless fidelity (“WiFi”) technology is inappropriate.

The apparatus (G-Box) can further include a Game Controller FIG. 3 (#103); a Master Menu with loadable help, instructions and game specific sound files (#104), Pluggable, Replaceable firmware game software whereby as a player broadens the game scope and, as casino gaming venues change with cable company variations, a zero insertion upgrade will increase a players spectrum of game selections.

Also includable in the Audio Processor FIG. 3 (#104) is an Audio daughter board containing an imbedded processor for all audio applications, a speaker and headphone drivers, and a synthesizer for game specific sound and audio, help files from the Game Controller to process an audio digitally selectable sub channel communication link where a casino and virtual casino offer on line audio, and live help through either direct I/O or a WiFi link. The WiFi link (#110) can be a specially adapted 802.11n distributed broadband wireless communication link supporting a standard 802.11n security protocol and additionally including an imbedded public key encryption chip linked with a box serial number identifier.

The Credit Card Reader (#112) can be included with a -removable/swappable credit card swipe and short range “tap” Radio-frequency identification (“RFID”) smart card reader to build an internal “personal bank” for placing bets, purchasing game boards or registering for casino services and for registering gaming activity with a casino specific “players card” for points and credit.

The Power Supply (#105) can include a Nickel Metal Hydride (“NiMH”) or Lithium Organic (“LiO”) rechargeable battery. An Alternating Current (“AC”) charger and power management to control the battery having a quick charge mode and be easily hot swappable with an additional small amp/hr battery to allow and not having to power down and interrupt games in progress.

The Display Touch Screen FIG. 3 (#113) can have a selectable high contrast mode for high ambient light conditions and be easily replaceable with rugged hinges.

A Utility Processor FIG. 3 (#105) is provided for power and control with low power processor for monitoring all critical applications (funds transfer, credit card confirmation, game status in low power situations) with essentially no interrupt for control to retain and process all critical information and act as the main controller during power up diagnostics and hardware trouble detection

Game progress is monitored to the detail specified by the player allowing the player to switch to an Active Monitor Mode (AMM), enabling a player's participation in other active table games as Black Jack or Craps or to search for an open table in a casino venue.

A broad band interactive digital cable interface FIG. 3 (111) is used to enable virtual gaming outside a casino venue while assuring state jurisdiction and control of all gaming, whereby the interactive cable interface enables a cable company to establish a World network, complete with a dedicated channel where players and non players view gaming complete with domestic and international feeds and States can authorize and control casino, virtual casino and “at home” player access via their high speed interactive digital cable networks and the games played are at the discretion of Governmental authorities.

Steps to operate are all touch screen initiated and conceptually:
Press the protected power on button
Wait while the G-Box completely check all the hardware
View the messages on the display or listen to them via the synthesized voice
Choose from the menu what you what gaming you wish
Swipe your “players” card to identify yourself to the “casino”
Purchase game cards or load personal bank via available methods
Close G-Box and put into AMM mode, wait for notification the game will be starting
   OR
Begin playing your gaming choice

Other steps include swiping a credit card; tapping a smart card reader. to build internally a Box “personal bank” for placing bets, purchasing game boards and registering for casino services.; registering gaming activity with a casino specific “players card” for points and credit, communicating via the voice help audio processor or even visiting the casino's special “walk about” gaming desk for help, upgrades or to just sit back and view the casino's real time “Games and facilities for G-Box users at our casino” —right on your G-Box as you relax in the lounge.

Further steps include monitoring all critical applications (funds transfer, credit card confirmation, game status in low power situations) with essentially no interrupt for control to retain and processes all critical information and act as the main controller during power up diagnostics and hardware trouble detection.

Monitoring of game progress is to the detail specified by the player allowing the player to switch to Active Monitor Mode (AMM), enabling a player's participation in other active table games as Black Jack or Craps or to search for an open table in a casino venue.

The Apparatus also includes virtual gaming outside a casino venue while assuring state jurisdiction and control of all gaming. The cable company in concert with the interactive cable interface enables a cable company to establish a World network, complete with a dedicated channel where players and non players view gaming complete with domestic and international feeds and States can authorize and control casino, virtual casino and “at home” player access via their high speed interactive digital cable networks, where the games played are at the discretion of the states.

While a particular embodiment of a method according to the present invention has been shown and described, it would be obvious to those skilled in the art that various other changes and modifications can be made without departing from the spirit and scope of the invention. It is therefore intended to cover in the intended claims all of such changes and modifications that are apparent to those of ordinary skill in the art.

What is claimed:

1. A game board presented in FIG. 1, comprising a matrix with a plurality of columns and rows, with each intersection of a row with a column forming a playing area and the first row including a possible alphabetic designation; and means for electrically or manually energizing separately each playing area.

2. A game board as defined in claim 1 having six rows and six columns with each intersection of a row and column defining an active playing area

3. A game board as defined in claim 2 and graphically shown in FIG. 1, where in the first column is alphabetically designated by the letter C and responds electronically and manually to numbers ranging from 1-18; the second column is alphabetically designated by the letter H and responds electronically and manually to numbers ranging from 19-36; the third column is alphabetically designated by the letter I and responds electronically and manually to numbers ranging from 37-54; the fourth column is alphabetically designated by the letter N and responds electronically and manually to numbers ranging from 55-72; the fifth column is alphabetically designated by the letter G and responds electronically and manually to numbers ranging from 73-90; and the sixth column is alphabetically designated by the letter O and responds electronically and manually to numbers ranging from 91-108; whereby said game board provides for 108 potential numbers.

4. A game board as defined in claim 3 wherein said numbers exceed the minimum number of selected items in a winning pattern in a conventional BINGO board game, thereby enabling a larger number of potential players and unique cards in a network gaming venue, and when used in a casino venue and played with paper cards, the games will last longer than conventional yet provide the same atmosphere and excitement where the number selection is still chosen through the traditional “air ball fall in the bin” process, whereby when the number of cards or bets a player can play exceeds 100, there is a dramatic increase in the bets, winnings and ease of play.

5. A game board as defined in claim 4 wherein interactive digital cable technology is enabled and a cable company becomes the facilitator of the game and gives local jurisdiction and control, with a cable operator supplying cable and Interactive digital cable box access, open Network channel(s) for marketing and hardware and entertainment infrastructure and can supply management structure for virtual or real casino operation and control.

6. A game board as defined in claim 5 wherein other games, such as Bingo and Keno can be played concurrently with increased betting, empowering non-gaming hall participant play.

7. Game board apparatus Presented in FIG. 3, comprising a touch screen, an operating System which is a virus resistant and has necessary drivers for Input/Output (I/O) and internal communications firmware; means for diagnoses upon startup and displaying an appropriate error message indicating any difficulty; including snap-in components configured as daughter boards on a mother board that can have slides/rails for easy removal/replacement; rechargeable batteries; means for loading game cards and information into a non-volatile flash memory, assuring no loss of gaming or betting information; means for saving game positional information upon a forced re-boot or inadvertent power down on a power
interrupt to allow an immediate network request for update that reloads all card/game parameters, immediately placing the user back in the game with no loss of a winning position.

8. Apparatus as defined in claim 7 comprising a base system delivered fully loaded with an Interactive Digital Cable Box interface, provided with Wireless Fidelity (WiFi) and Touch screen with graphics, a Credit Card reader supporting both card swipe and Radio Frequency Identification (RFID) technologies, Audio Help and Introduction Script memory (volatile and Flash) and an operating system to be fully operational in any enabled environment.

9. Apparatus as defined in claim 7 comprising a Touch Screen Display with protected switches to avoid accidental operation, including the following switches: Power (on-off)-“Lighted” (Green-on, Red-off); Standby (on-off); “Lighted Toggle” (Green-normal, Red-Standby);’ a: Large Illuminable Switch (flashing upon a win); Smaller duplicate illuminable switch (flashing on edge while in closed “monitor” mode); and Indicator Lights to indicate Charging (flashing Red); Charge indication (tri-color): Continuous Bat. Condition (Green-50-100%; Yellow-20-50%; Red-5-20%; Flashing Red and tone at <5% with Low Power mode message

10. Apparatus as defined in claim 7 further comprising Twin Speakers with mini-volume rocker switching, Re-Boot indication (“Lighted”) and Protected Emergency System Re-Boot indication (Red while enabled); Power Charger input, Plug for Earphone and Microphone, a common cable communication channel likened to “ether” (“Ethernet”); a serial bus interface for high-speed communication and isochronous real-time data transfer; Universal Serial Bus (“USB”) Ports, a Multi-mode Fiber Dual Personal Computer (PCI) Card slot; Display output; Swipe Credit Card Reader; Personal Identification Verification (“PIV”) Processor; Mother board with Electrical Erasable Programmable Read Only Memory (“EEPROM”) on board operating system complete with standard Input-output (“I/O”) drivers and display interface; volatile memory, Flash non-volatile memory, Basic Display processor, Basic Audio board, a Standard touch screen with high light visibility, Rechargeable Battery, Daughter Board optional add on adapters, and an Operating System Quick Charger

11. Apparatus as defined in claim 7 comprising a Mother Board containing a microprocessor and back plane interface with pluggable daughter board pins for an Operating System, an operational memory, a flash non volatile memory for “loaded” game boards (matrix), Keno, Lotto and Roulette betting and play selections; an Advanced Graphical Processor which is pluggable and upgradeable with imbedded micro processing and memory to control graphical display enabling a four-way split screen presentation of game status, menu control, finger icon drag and real time video and audio on a single screen; wherein the graphical processor presents not only a gaming matrix and real time video but also animated slots and Japanese and Chinese symbols and their associated chance games; and means for allowing direct connection and alternative interfacing to all variations of casino and private networks for operation and downloading when distributed broadband wireless fidelity (“WIFI”) technology is inappropriate.

12. Apparatus as defined in claim 7 further including a Game Controller; Pluggable, Replaceable firmware game software whereby as player broadens game scope and as casino gaming venues change with cable company variations a zero insertion upgrade will increase a players spectrum of game selection and including a Master Menu with loadable help, instructions and game specific sound files.

13. Apparatus as defined in claim 7 further including an Audio daughter board containing an imbedded processor for all audio applications, a speaker and headphone drivers and a synthesizer for game specific sound and audio, help files from Game Controller to process an audio digitally selectable sub channel communication link where a casino and virtual casino offer on line audio, and live help through either direct I/O or WiFi link.

14. Apparatus as defined in claim 7 further including a WiFi specially adapted 802.11n distributed broadband wireless communication link supporting a standard 802.11n security protocol and additionally including an imbedded public key encryption chip linked with a box serial number identifier.

15. Apparatus as defined in claim 7 further including a Credit Card Reader with a removable/swappable credit card swipe and short range “tap” RFID smart card reader to build internal a Box “personal bank” for placing bets, purchasing game boards or registering for casino services and for registering gaming activity with the casino specific “players card” for points and credit.

16. Apparatus as defined in claim 7 further including a Power Supply, a NiMh/LiOn rechargeable battery, ac charger and power management controls with the battery having a quick charge mode and be easily hot swappable.

17. Apparatus as defined in claim 7 further including a Display Touch Screen with a selectable high contrast mode for high ambient light conditions and easily replaceable with rugged hinges.

18. Apparatus as defined in claim 7 further including a Utility Processor for Power and control with low power processor for monitoring all critical applications (funds transfer, credit card confirmation, game status in low power situations) with essentially no interrupt for control to retains and processes all critical information and act as the main controller during power up diagnostics and hardware trouble detection

19. Apparatus as defined in claim 7 further including means for monitoring game progress to the detail specified by the player allowing the player to switch to Active Monitor Mode (AMM), enabling a player's participation in other active table games as Black Jack or Craps or to search for an open table in a casino venue.

20. Apparatus as defined in claim 7 further including a broad band interactive digital cable interface that enables virtual gaming outside a casino venue while assuring state jurisdiction and control of all gaming, whereby the interactive cable interface enables a cable company to establish a World network, complete with a dedicated channel where players and non players view gaming complete with domestic and international feeds and States can authorize and control casino, virtual casino and “at home” player access via their high speed interactive digital cable networks and the games played are at the discretion of the states.
